(19) United States
(12) Patent Application Publication
(10) Pub. No.: US 2003/0070145 A1
(43) Pub. Date: Apr. 10, 2003

(54) Visual funeral planning system

(76) Inventors: Chris Barnes, Indianapolis, IN (US); Troy Brake, Nobelsville, IN (US); Gary Munchel, Oldenburg, IN (US)

Correspondence Address: WOOD, HERRON & EVANS, L.L.P., 2700 Carew Tower, Cincinnati, OH, 45202, US

(21) Appl. No.: 09/973,622

(22) Filed: Oct. 9, 2001

(51) Int. Cl. G09G 5/00

(52) U.S. Cl. 715/515; 345/700

(57) ABSTRACT

An apparatus, method and program product superimpose image data to enable visual configuration of funeral item combinations. A remote network server prompts retrieval of the image data from a local database.

### FIELD OF THE INVENTION

This invention relates generally to the death care industry, and more particularly to computer-assisted methods of planning funerals and other memorial services.

### BACKGROUND OF THE INVENTION

Upon the death of a family member, surviving loved ones must make a number of decisions in a relatively short time. Too often a bereaved loved one may feel pressured and overwhelmed by memorial preparations. Exemplary memorial decisions encompass ceremony preferences, financial arrangements, casket or urn selections, etc.

Other considerations relate to transportation, floral displays, as well as “personalizing” products and services. For instance, clients routinely customize materials, finishes, corner adornments and interiors of caskets to honor loved ones. Likewise, “memorial items” or keepsakes may be tastefully incorporated into aspects of a memorial service. While such services and personal touches facilitate the healing processes, they often represent difficult choices for bereaved loved ones.

Funeral plans, and in some cases, preplans are conventionally created in an “arrangement conference.” In such a conference, a funeral director meets with a pre-planner or surviving loved one of the deceased. The conference is typically held in the funeral home of the funeral director, who describes and discusses various funeral products, services and costs. The funeral director may use visual aids, such as a product catalog, product display board and a casket selection room to illustrate the products available to the customer. Similar catalogs may be employed to give a sense for the services offered by a funeral.

Some death care providers attempt to accommodate client insecurities and schedules by tapping into Internet resources. Commercial Internet applications have become ubiquitous in nearly every other industry, and funerary providers likewise recognize advantages inherent to the technology. For instance, digitized listings of funeral products and services are displayed on Internet web pages maintained by funeral suppliers and providers. Such web pages allow browsers limited exposure to select products and other aspects of a memorial process.

Web pages can be helpful in familiarizing clients with select products and services prior to an arrangement conference. However, while they may facilitate preplanning, conventional web site applications often prove impractical or inadequate in the context of most planning scenarios since many clients do not preplan. Time constraints, as well as grieving issues and a need for local contacts may frustrate unassisted online attempts. Consequently, in many situations a planning session preferably incorporates the experience, local familiarity and personal attention of a funeral director. As such, the director can competently address details and crucial intangibles associated with a funeral or memorial service.

To this end, some funerary service providers combine aspects of both Internet and personalized funeral home services. Namely, funeral directors may establish a networked connection within their funeral home to facilitate planning. Conventionally, a funeral director will seat family members in front of a computer terminal that is in communication with a network server. The server may download funeral pricing, product and service information to the funeral home terminal in response to queries and other input from the director. In this manner, the director retrieves information from a network database in order to manually configure a funeral plan.

Notwithstanding the physical presence of the director, however, grieving family members may perceive such systems as merely offering a disjointed, impersonal listing of products and services. Further, while some funerary software programs make some provision for downloading photographs from the network, bandwidth limitations often render the display of such images slow and cumbersome, resulting in awkward delays. For instance, a download of a casket image may require most of a minute, which can disrupt the flow of a planning session. Moreover, the downloaded image is generally too small (in deference to bandwidth considerations) to accurately reflect or convey a true sense of the product. Consequently, providers are relegated to locating photographs of products within voluminous catalogs. Displaying catalogued images as such further breaks the flow of a session and largely defeats the purpose of online planning.

In addition to such imaging obstacles, known systems are further incapable of imparting to a client a sense of how complimentary items will appear in relation to each other. Namely, catalog and other images of funeral options, such as cap panels, are routinely photographed against neutral backdrops. As such, grainy computer images and disjointed catalog references fail to convey an impression of how a selected corner adornment or engraving plate will appear when affixed to a desired casket model. As may be appreciated, the visual interaction of complimentary funerary selections can dramatically affect the overall impression of the entire ensemble. For example, where a catalog photograph of a corner adornment may appeal to a client when viewed separately, the same adornment may precipitate an unforeseen color or style clash when affixed to the casket.

For the foregoing reasons, grieving loved ones must still make an emotionally traumatic journey through a casket room to view how, for instance, a selected cap panel will actually complement a chosen casket. Significantly, such a viewing presupposes that the funeral home has the space and inventory available to display items selected at the computer terminal and/or catalog. Such overhead considerations can pose serious challenges and even be preclusive to many funeral home operations.

Still another shortcoming of prior art systems regards their inability to intelligently guide user options based upon their compatibility with prior selections. The nature of prior art methods permits a client to select items, such as the above discussed adornment, in more or less an ala carte fashion. That is, individual items may be separately added to an aggregate order of the client, largely without regard for other items. As such, a client may consider and possibly order options that are incompatible with each other, translating into client frustration and wasted time. Such may be the case where a client reviews corner adornments for a desired steel casket model that does not accept adornments.

Another product listing may include items unavailable to the local provider. Thus, the provider is relegated to the tedious and complex task of manually verifying and guiding clients through appropriate, complimentary options. Conventional programs may compound such confusion by leaving the client without a comprehensive listing of items selected during a session, further burdening the director with reconstituting and organizing orders to be in a format suitable for client digestion.

Consequently, what is needed is a method of arranging a memorial in a manner that allows for more convenient, thoughtful and comprehensive planning than has heretofore been possible.

### SUMMARY OF THE INVENTION

The present invention relates in one aspect to a method, apparatus and program product configured to superimpose an overlay image on top of a base image. The overlay and base images may visually combine in such a manner as to form a composite image.

More particularly, a database resident within a memory may maintain the images in a manner accessible to a program. For instance, the database may store funeral items in an associative relationship with respect to their correlated images. Of note, the database and associated images may be stored on a local computer of the user. As such, a remote network server may initiate the display of the images from the local database.

The program further provides an interface adapted to allow the user to enter product information relating to funeral products, services and pricing information. The program may further generate a comprehensive plan for the user relating to the funeral items.

These and other features and advantages of the present invention will become more readily apparent during the following detailed description taken in conjunction with the drawings herein.

### BRIEF DESCRIPTION OF THE DRAWINGS

FIG. 1 is a block diagram of a networked computer system consistent with the invention;

FIG. 2 is a block diagram of an exemplary hardware and software environment for a computer from the networked computer system of FIG. 1;

FIG. 3 is a flowchart having method steps suited for execution within the hardware and software systems of FIGS. 1 and 2;

FIG. 4. is a relational database adapted to maintain funeral data used by the process steps of FIG. 3;

FIG. 5 is a digitalized image of a casket retrieved from the database of FIG. 4;

FIG. 6 is a display of thumbnail images maintained within the database of FIG. 4;

FIG. 7 is a display of a cap panel suited for attachment to the casket shown in FIG. 5;

FIG. 8 is a composite image of the cap panel image of FIG. 7 superimposed over the casket image of FIG. 5;

FIG. 9 is the composite image of FIG. 8 further augmented with a corner adornment image selected from among the thumbnail images of FIG. 6.

### DETAILED DESCRIPTION

The present invention relates to an apparatus, computer-implemented method and program product configured to select and arrange funeral products. A program of the invention may respond to user input by superimposing an image of a correlated funerary item over a base image in such a manner as the resultant, composite image imparts an accurate sense of how the items appear in spatial relationship to each other. For instance, a superimposed image may feature a photograph of a correlated item against a transparent backdrop. As such, only the photograph portion of the superimposed image is apparent when overlain the base image, which could likewise comprise a product photograph. In this manner, a family member may visualize how superimposed selections will appear in relation to previously chosen products. Of note, while a correlated item may embody an accessory or additive feature with regard to the base item, the items may alternatively be functionally unrelated.

The near real time visual configuration of complimentary funeral products may also be facilitated by the storage of associated images on the local hard drive of the user. In this manner, instructions from a network server may prompt the display of images from local memory without necessitating preclusive bandwidth delays. Moreover, programming logic underlying the visualization software ensures that displayed images are, in fact, compatible with overlain images. Of note, exemplary images are not limited to photographs in the context of the present invention, and may include artistic renderings, schematics, digitalized documents, maps and other electronically transferrable media.

### Hardware and Software Environment

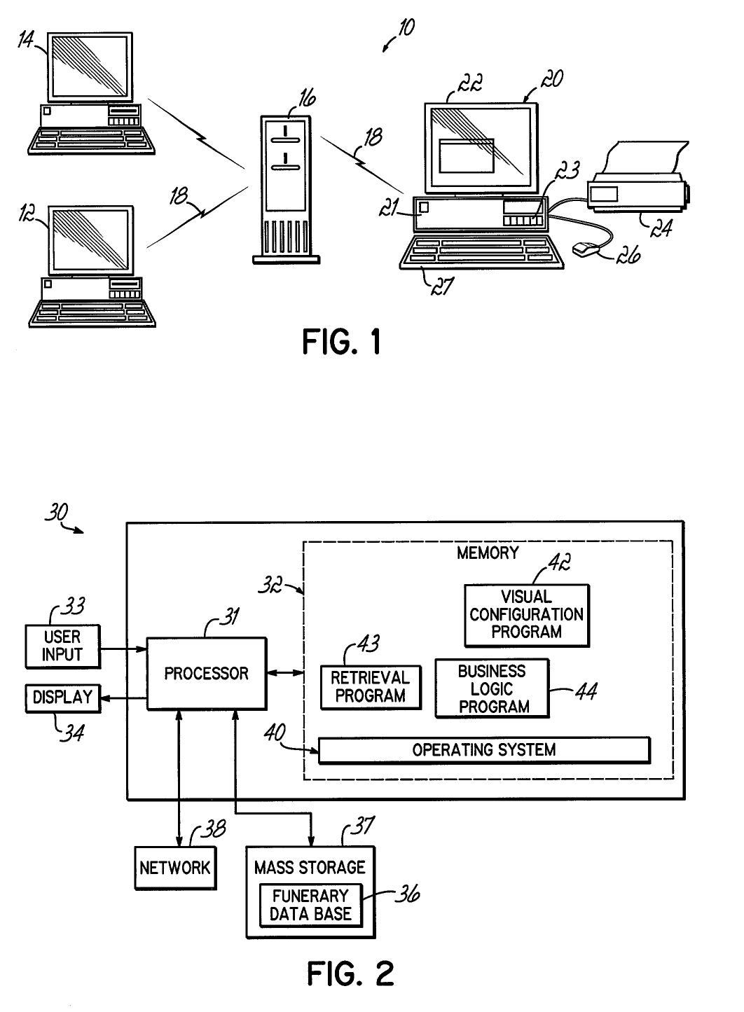

Turning to the Drawings, wherein like numbers denote like parts throughout the several views, FIG. 1 illustrates a computer system 10 suited to implementing online funeral planning in a manner consistent with the invention. Computer system 10 is illustrated as a networked computer system including one or more client computers 12, 14 and 20 (e.g., desktop or PC-based computers, workstations, etc.) coupled to server 16 (e.g., a PC-based server, a minicomputer, a midrange computer, a mainframe computer, etc.) through a network 18. Network 18 represents a networked interconnection, including, but not limited to local-area, wide-area, wireless, and public networks (e.g., the Internet). Moreover, any number of computers and other devices may be networked through network 18, e.g., multiple servers.

User computer 20, which may be similar to computers 12, 14, may include: a central processing unit (CPU) 21, a number of peripheral components such as a computer display 22, a storage device 23, a printer 24, and various input devices (e.g., a mouse 26 and keyboard 27), among others. Server computer 16 may be similarly configured, albeit typically with greater processing performance and storage capacity, as is well known in the art.

FIG. 2 illustrates a hardware and software environment for an apparatus 30 suited for visually planning a funeral in a manner consistent with the principles of the invention. For the purposes of the invention, apparatus 30 may represent a computer, computer system or other programmable electronic device, including: a client computer (e.g., similar to computers 12, 14 and 20 of FIG. 1), a server computer (e.g., similar to server 16 of FIG. 1), a portable computer, an embedded controller, etc. Apparatus 30 will hereinafter also be referred to as a “computer,” although it should be appreciated the term “apparatus” may also include other suitable programmable electronic devices consistent with the invention.

Computer 30 typically includes at least one processor 31 coupled to a memory 32. Processor 31 may represent one or more processors (e.g., microprocessors), and memory 32 may represent the random access memory (RAM) devices comprising the main storage of computer 30, as well as any supplemental levels of memory, e.g., cache memories, non-volatile or backup memories (e.g., programmable or flash memories), read-only memories, etc. In addition, memory 32 may be considered to include memory storage physically located elsewhere in computer 30, e.g., any cache memory in a processor 31, as well as any storage capacity used as a virtual memory, e.g., as stored within a funeral database 36 or on another computer coupled to computer 30 via network 38.

Computer 30 also may receive a number of inputs and outputs for communicating information externally. For interface with a user, computer 30 typically includes one or more input devices 33 (e.g., a keyboard, a mouse, a trackball, a joystick, a touchpad, and/or a microphone, among others) and a display 34 (e.g., a CRT monitor, an LCD display panel, and/or a speaker, among others). It should be appreciated, however, that with some implementations of computer 30, e.g., some server implementations, direct user input and output may be unsupported by the computer, and interface with the computer may be implemented through client computer or workstation networked with computer 30.

For additional storage, computer 30 may also include one or more mass storage devices 37 configured to store a funeral database 36. Exemplary devices 37 can include: a floppy or other removable disk drive, a hard disk drive, a direct access storage device (DASD), an optical drive (e.g., a CD drive, a DVD drive, etc.), and/or a tape drive, among others. Furthermore, computer 30 may include an interface with one or more networks 38 (e.g., a LAN, a WAN, a wireless network, and/or the Internet, among others) to permit the communication of information with other computers coupled to the network. It should be appreciated that computer 30 typically includes suitable analog and/or digital interfaces between processor 31 and each of components 32, 33, 34, 36 and 38.

Computer 30 operates under the control of an operating system 40, and executes various computer software applications, components, programs, objects, modules, etc. (e.g., visual configuration program 42, image retrieval program 43, business logic program 44 among others). Moreover, various applications, components, programs, objects, modules, etc. may also execute on one or more processors in another computer coupled to computer 30 via a network 38, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions will be referred to herein as “computer programs,” or simply “programs.” The computer programs typically comprise one or more instructions that are resident at various times in various computer memory and storage devices. When a program is read and executed by a processor, the program causes the computer to execute steps or elements embodying the various aspects of the invention.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

### Visually Configuring a Funeral Plan

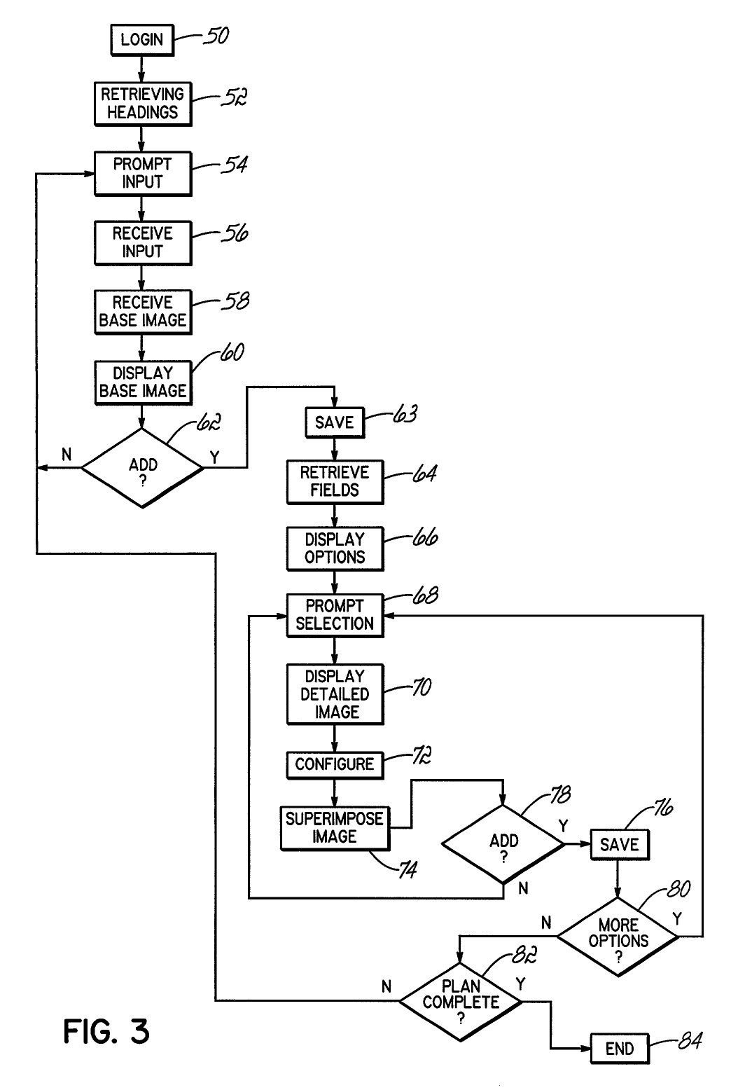

FIG. 3 is a flowchart embodying method steps suited for execution within the hardware and software environments of FIGS. 1 and 2. Namely, the exemplary processes allow clients to visually render funeral selection combinations as they plan a memorial service online. For instance, the visual configuration program 42 of FIG. 2 may superimpose digitally stored, sized and oriented images of funeral items over a base funeral image. As such, a client may readily perceive how complimentary products appear in spatial relationship to each other, translating into greater planning flexibility and confidence. Programming logic underlying the visualization software and embodied in the logic program 44 of FIG. 2 further ensures that displayed images are, in fact, compatible with overlain images.

In a preferred embodiment, the exemplary steps of FIG. 3 are thus executed by the computer 20 and associated programs 42-44 of FIG. 2. The computer 20 is preferably located at a funeral home. As such, a director or other service provider may cue and interact with local and/or network software to establish a funeral plan using input from loved ones visiting the home. The computer preferably networks to a central server running planning software. However, a portion or all of the funeral planning software may also execute at the local computer. For instance, the below text accompanying the method steps of FIG. 3 discuss how the retrieval program 43 of FIG. 2 may recall image data from a local and/or network database in response to user input.

The computer terminal may physically be configured within the home such that family members may gather around a monitor as the director steers the computer implemented planning session. As discussed below, care is taken to make the execution of the program flow like a tailored presentation, rather than that of an impersonal, fact-gathering exercise. To this end, splash screens and computer prompts are personalized with images and other data cued by the program in response to categorical and theme related data input at block 52 of FIG. 3. Thus, the computer and associated software may act as an informational aide and planning tool that complements the personal attention of the funeral director.

Turning more particularly to FIG. 3, the funeral director may log into the computer and/or network at block 50. A login session typically includes the director providing a user ID and password for security and privacy considerations. Of note, the funeral director may have an option of exercising separate login sequences for the purpose of accessing different domains, or web addresses.

As discussed below, one user ID may direct the computer browser to a domain that allows the director to add, delete or otherwise modify pricing and product information retrieved by the program and displayed to clients. For instance, a director may wish to update costs or availability status regarding a particular product or service. Moreover, the director may account for local services and products. One embodiment further allows the director to download their own images into the database, such as a photograph of funeral home viewing area. As such, downloaded images may be retrieved by program code for inclusion within a composite, superimposed image, e.g., to illustrate how funeral items would be placed in a viewing room. Doing so would permit, for example, a client to determine how particular products would appear in a particular setting.

Another login ID and scenario at block 50 may cause the computer browser to retrieve planning topic headings at block 52. Exemplary headings displayed to both providers and family members at block 52 may comprise links to various software planning screens that address contact data, documents, packages and product options conventionally associated plans. The presentation and options associated with such planning topics offer the funeral director and family members flexibility and guidance during a planning session.

Some topics may be mandatory, such as those directed at gathering required information concerning family members and the deceased. As such, an introductory splash screen may prompt the director and/or client to submit personal information, such as names, addresses and general information concerning family members. In addition to gathering information required to plan and fund a funeral, the program may process user input in such a manner as to personalize the planning process. For instance, a family member may submit personal information, such as a hobby or interest of the deceased at block 52. Namely, a family member may wish a memorial service to reflect a career in the Armed Forces or an enthusiasm for fishing. As discussed below, program code may associate interests input to the computer with theme fields of a database. Theme fields thus associated with both products and program prompt screens may receive a programmatic preference and may carry over to all aspects of a planning session. Namely, the program may seek out a designated theme field applicable to each planning heading.

Similarly, user input regarding the religion, gender and age of the deceased may prompt software to alter the presentation and content of subsequent steps and topic headings. For instance, a submitted interest in gardening may be reflected in background screens downloaded to the funeral home terminal. Namely, an exemplary background screen may include a photograph of a flower bed or a collage of gardening tools. Family members of a deceased, avid golfer may view questions and product options tailored to golf enthusiasts. Such subtle personalization can make family members feel more at ease and ultimately contribute to a more fulfilling planning session. An application of theme-related planning is disclosed in U.S. patent application Ser. No. 09/827,803 entitled SYSTEM AND METHOD OF PLANNING A FUNERAL, filed on Apr. 6, 2001, which is hereby incorporated by reference herein in its entirety. As with the login procedures of block 50, a director may elect to enter much of the preliminary information known to the provider prior to the family's arrival at the funeral home. As such, clients are initially greeted with tailored prompts and displays configured by the program.

Still other topic headings offered at block 52 regard actual fimeral product and service selection. At an appropriate point during a session, the funeral service provider may designate a heading linked to product information, perhaps by clicking on a displayed “products” link. Program code accordingly initiates a display of a product selection screen at block 54. An exemplary screen may display various images and/or text relating broadly to funeral product categories, such as caskets, urns, outer burial containers, floral arrangements, and/or memorial markers.

As above, the director may select a funeral product category by clicking on the link. The link preferably initiates display of a scroll down screen listing more specific products of the category. For example, a client selection of “caskets” may precede a scroll bar menu of casket models. Of note, the display information may relate to specific casket models, or may be merely exemplary, themselves, prompting the user to consider a general style. Significantly, the scroll down window may reflect a list of products tailored to those available to the funeral serve provider. For instance, the service provider may tailor the list to track inventory at a local warehouse when entering and modifying product information at block 50.

At block 56, the client indicates a product preference. The client designation, in turn, prompts program software to retrieve information regarding the selected product from a database at block 58. In a preferred embodiment, such information is retrieved from the local hard drive of the computer. Local storage enables quick retrieval of stored information. As discussed below, this feature has particular application with regard to large images. In this manner, instructions generated from the network server may direct execution of a planning program resident on the local machine.

The funeral service provider may install such a program on the local computer prior to the online planning session. An installation disc may additionally install image data onto the hard drive of the local computer. As such, the network instructions prompt the local program to retrieve the image data on demand from resident memory. Although similar data may be retrieved from a network database and downloaded to the local terminal, the local storage of images is preferred. Namely, the local storage facilitates speedy image display, sparing clients lengthy and awkward download sessions. Moreover, the local storage enables larger images to be displayed in the absence of associated bandwidth restrictions.

Other embodiments may combine aspects of both local and network image retrieval methods. For instance, user input may prompt a network instruction targeting the display of a given funeral image. A retrieval program resident on the local computer may initially check local memory for the image. Should the image be thus unavailable locally, then the program may initiate a download of a funeral image from the network. Preferably, the program then caches the downloaded image within local memory in anticipation of subsequent use.

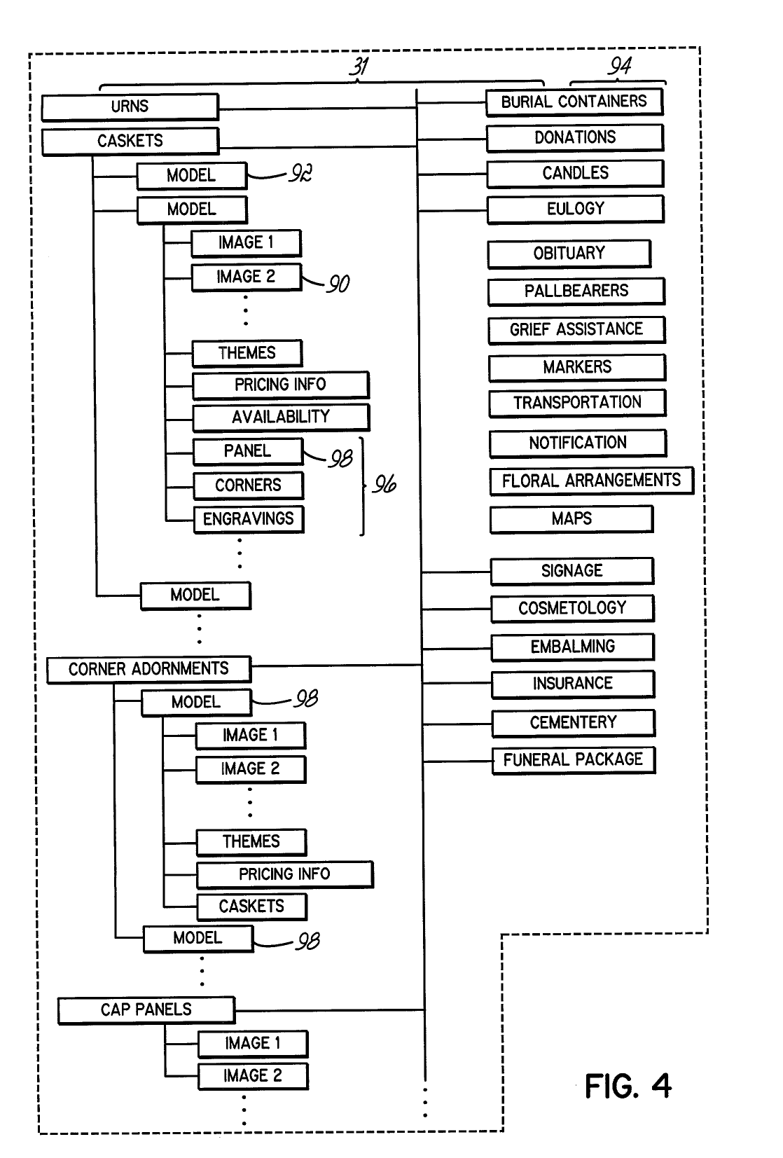

The relational database 36 of FIG. 4 shows exemplary categories of funeral product and service information stored within the memory 32 of FIG. 2. As discussed above, the illustrative fields of the database 36 may be upgraded and modified by a service provider locally or via the network. As such, a comprehensive database may maintain information regarding products from national suppliers, as well as services available on only a local basis. Column 94 of FIG. 4 shows fields associated with some such exemplary products/services.

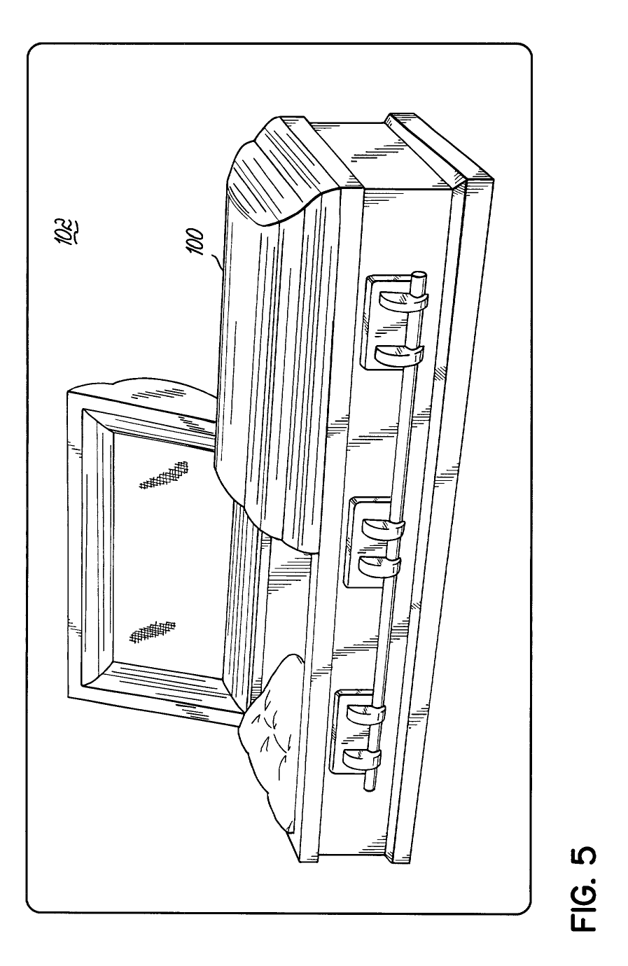

At block 58 of FIG. 3, the planning program may retrieve a base image from a field 90 of FIG. 4. The field 90 corresponds to the casket product 92 selected at block 58 of FIG. 3. Accordingly, the base image of the corresponding casket may be displayed at the terminal for client viewing at block 60. FIG. 5 shows a digitalized image 102 retrieved from field 90 of FIG. 4 in response to a client selection of the associated casket model 92. Because the image of the casket 100 of FIG. 5 is retrieved from the local hard drive of the computer, it is instantly displayed on the client monitor despite its relatively large size. Of note, the orientation and dimensions of the casket 100 relative to the overall image 102 of FIG. 5 may be standardized as among other database image fields 91 of FIG. 4. As discussed below, such consistency can facilitate the uniform overlaying of correlated images. A single product model may nonetheless have numerous associated images exhibiting different, though standardized views.

The client may elect to add the base product selection to their funeral plan at block 62. By thus storing the selection at block 63, the program code records and associates information it uses to align and logically guide client interaction through subsequent steps. More particularly, the embodiment may rely on the database structure of FIG. 4 to limit access to only those fields associated with the selected product(s). This provision ensures that the client will only consider complimentary products and options actually compatible with and available for the specified products.

In this manner, complementary options relating to the selected product may be retrieved from the database. As shown in FIG. 4, correlated data within fields 96 that correspond to the selected product 92 are retrieved and displayed at blocks 64 and 66 of FIG. 3, respectively, for the consideration of the client. Of note, such a display may comprise general text, or a thumbnail image of exemplary product options. For example, the program may initiate a general display of a cap panel, engraving a corner adornment after checking the database relationships of FIG. 4 to verify which options are available for the casket model 92 saved at block 63 of FIG. 3.

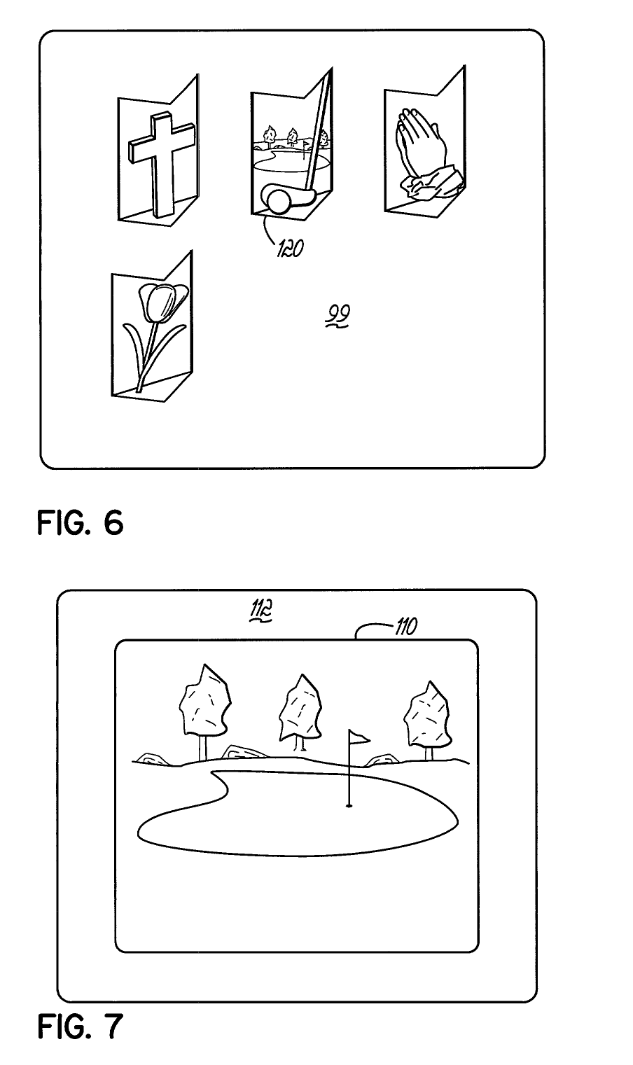

As such, the user may be queried at block 68 as to whether they wish to consider a displayed option, such as casket adornments. An affirmative response at block 68 of FIG. 3 causes the program code to retrieve data specific to adornments and having database fields 98 associated with the manufacture of the selected casket model 92 of FIG. 4. In this manner, one embodiment may display a text or pictorial listing of available/retrieved adornment options at block 66. FIG. 6 shows one such exemplary display of corner adornment images 99 that may be downloaded for the consideration and potential inclusion of the client at block 68 of FIG. 3. As such, each thumbnail image 99 of FIG. 6 may represent a link to more specific information regarding the respective corner adornment.

After the client has considered and briefly reviewed displayed options at block 66, program code may prompt the user to investigate an option further at block 68. For instance, the client or funeral service provider may wish to view a large prospective image of a corner adornment, cap panel or other option offered at block 66. As such, the user may click on the thumbnail image or text associated with, for instance, an appealing cap panel. At block 70, the database image correlated with the cap panel designated at block 68 may be retrieved and displayed as above. Of note, items may be displayed as closeups on a flat level presentation surface to convey more specific details about the item. FIG. 7 shows one such display for a golf enthusiast cap panel 110. Local storage of the image 112 again enables immediate display of larger images.

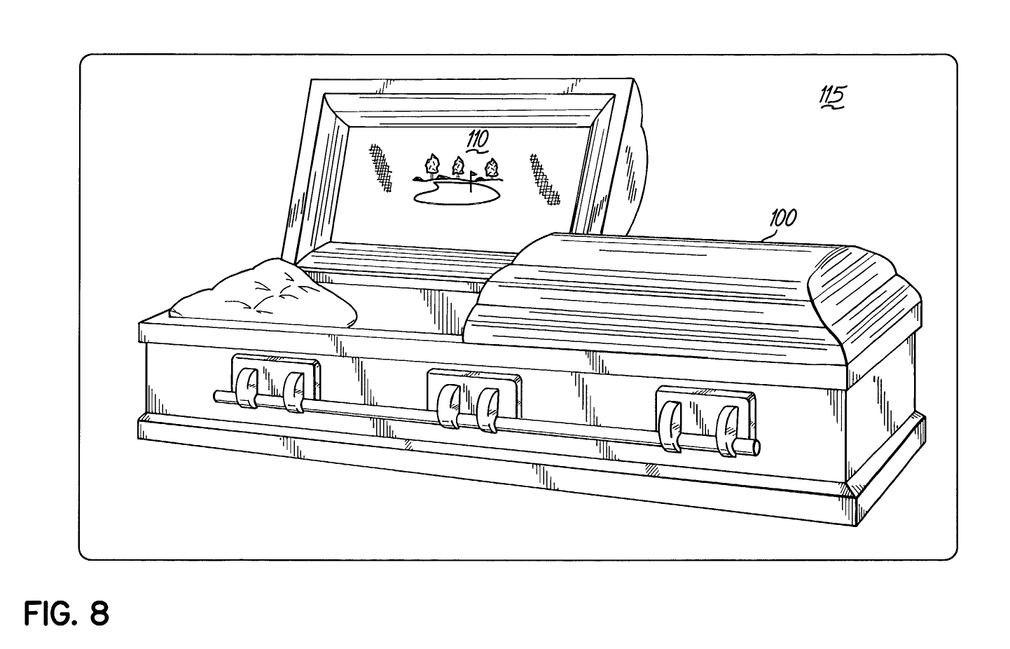

Should the client decide to consider the cap panel 110 of FIG. 7 further at block 72 of FIG. 3, they may click a configure/select button. As shown in FIG. 8, a visual configuration program may superimpose a fitted image of the correlated cap panel 110 item onto the base casket 100 image. More particularly, a perspective view of the golf cap panel 110 of FIG. 7 is overlain the casket selected at block 62 of FIG. 3. Of note, the overlain cap panel 110 image is sized, shaded, oriented and aligned to convey to the client an accurate representation of how the cap panel 110 will complement the casket 100 when attached. In this manner, the embodiment renders an accurate visual representation of how the correlated products actually appear together at block 74 of FIG. 3. A client is thus empowered to make other selections based upon their impression of the composite image 115 of FIG. 8.

Namely, based upon client perception of the combination at block 74 of FIG. 3, the client may disregard the correlated option item at block 78 in favor of another option offered at block 68. Alternatively, should the client wish to save or add the correlated item (cap panel) to their funeral plan, they may do so at block 76. The client may then be prompted at block 80 of FIG. 3 as to whether they wish to consider including more correlated options with regard to the base item and other saved features. If not, then the client may end their session at block 84 or continue with another base item at block 54.

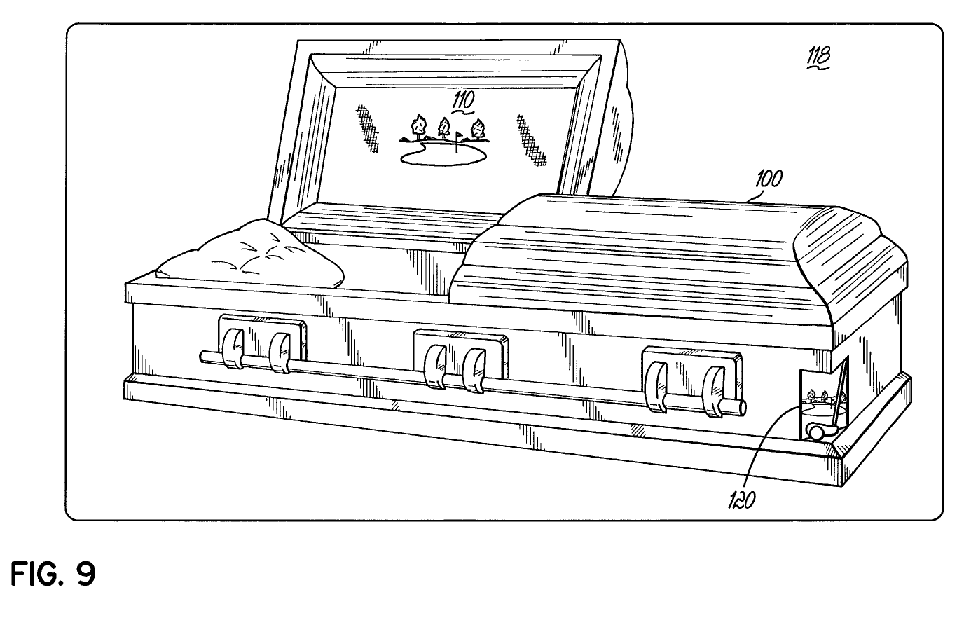

Should the client consider more personalized options at block 80, then the saved base overlay images are cached in local memory to accommodate further superimposed images. As such, the program visualization software enables the client to continue to overlay images and construct an accurate representation of how all items will appear in aggregate. FIG. 9 shows an image 118 of the base casket 100 of FIG. 5 with the cap panel 110 of FIG. 7 and a corner adornment 120 of FIG. 6 superimposed thereon. In this manner, a client may overlay additional images over the combined image 122 prior to purchasing, limited only by product compatibility considerations.

Those skilled in the art will readily recognize numerous adaptations and modifications which can be made to the present invention that will result in an improved method of planning funerals and other memorial services, yet all of which will fall within the spirit and scope of the present invention as defined in the following claims. For instance, visual configuration as discussed herein has application within virtually every aspect of funeral planning. Namely, base images of urn, funeral homes, vehicles, monuments, floral and candle images, etc., may be overlain and digitally augmented with superimposed images embodying funeral options. Accordingly, the invention is to be limited only by the scope of the following claims and their equivalents.

What is claimed is:

1. A computer implemented method for guiding a funeral planning session, comprising:
displaying a base image of a funeral item;
superimposing an overlay image of a correlated item over the base image in response to a user selecting the correlated item in such a manner as to form a composite image.

2. The method according to claim 1, further comprising storing image data selected from a group consisting of: the base image, the overlay image and the composite image, and some combination, thereof, within a database.

3. The method according to claim 2, further comprising retrieving the image data from the database.

4. The method according to claim 2, wherein the base image comprises a depiction of a viewing room, and wherein the overlay image comprises a depiction of a funeral product, and wherein the composite image depicts placement of the funeral product in the viewing room

5. The method according to claim 2, wherein the database is resident at a local computer.

6. The method according to claim 5, further comprising initiating the retrieval of the image data in response to an instruction from the remote network server.

7. The method according to claim 2, further comprising providing interface programming adapted to enable a user to enter product information to the database in response to user input.

8. The method according to claim 7, wherein the product information includes image data.

9. The method according to claim 7, wherein the product information relates to funeral data selected from a group consisting of: a service, a product, and some combination, thereof.

10. The method according to claim 2, further comprising entering pricing information relating to the funeral and correlated items into the database.

11. The method according to claim 10, further comprising retrieving the pricing information from the database.

12. The method according to claim 1, further comprising designating the correlated item in response to the user selecting a theme.

13. The method according to claim 12, wherein the theme is selected from a group consisting of: a hobby, an interest, a religious affiliation, a physical characteristic, an occupation, and some combination, thereof.

14. The method according to claim 12, further comprising tailoring an aspect of the funeral planning session according to the theme.

15. The method according to claim 12, further comprising tailoring a display according to the theme.

16. The method according to claim 1, wherein at least one of the images is a photograph.

17. The method according to claim 1, wherein the items are selected from a group consisting of: a casket, a corner adornment, a cap panel, an urn, an engraving and some combination, thereof.

18. The method according to claim 1, further comprising generating a comprehensive plan that includes the funeral and correlated items.

19. The method according to claim 18, further comprising printing the plan.

20. The method according to claim 1, further comprising prompting user input relating to the funeral planning session.

21. The method according to claim 1, further comprising overlaying an additional image over the composite image.

22. A method of selecting a funerary product from a local computer networked to a remote server, the local computer having a database that maintains at least one image associated with at least one of a plurality of funeral items, comprising:
retrieving the image from the database in response to a request from the remote server; and
thereafter displaying the image on the local computer.

23. An apparatus, comprising:
a memory;
a database resident in the memory, the database storing images associated with a plurality of funeral products; and
a program configured to access the database and retrieve a base image associated with one of the plurality of funeral items, display the base image, and superimpose an overlay image of a correlated item of the plurality of funeral items over the base image in such a manner as to form a composite image.

24. The apparatus of claim 23, wherein the program retrieves image data stored at the database and selected from a group consisting of: the base image, the overlay image and the composite image, and some combination, thereof.

25. The apparatus of claim 23, wherein the program accesses the database from a remote network server.

26. The apparatus of claim 23, wherein the database is resident at a local computer.

27. The apparatus of claim 24, wherein the program initiates the retrieval of the image data in response to an instruction from the remote network server.

28. The apparatus of claim 23, wherein the program provides an interface adapted to enable a user to enter product information to the database.

29. The apparatus of claim 23, wherein the product information includes image data.

30. The apparatus of claim 28, wherein the product information relates to funeral data selected from a group consisting of: a service, a product, and some combination, thereof.

31. The apparatus of claim 23, wherein the program facilitates entering pricing information relating to the funeral and correlated items to the database.

32. The apparatus of claim 31, wherein the program initiates retrieval of the pricing information from the database.

33. The apparatus of claim 23, wherein the program determines the correlated item in response to the user selecting a theme.

34. The apparatus of claim 33, wherein the theme is selected from a group consisting of: a hobby, an interest, a religious affiliation, a physical characteristic, an occupation, and some combination, thereof.

35. The apparatus of claim 33, wherein the program tailors an aspect of the funeral planning session according to the theme.

36. The apparatus of claim 33, wherein the program tailors a display according to the theme.

37. The apparatus of claim 23, wherein the program associates the funeral item with the base image.

38. The apparatus of claim 23, wherein the program associates the correlated item with the overlay image.

39. The apparatus of claim 23, wherein the program generates a comprehensive plan that includes the funeral and correlated items.

40. The apparatus of claim 39, wherein the program initiates printing the plan.

41. The apparatus of claim 23, wherein the program prompts user input relating to the funeral planning session.

42. The apparatus of claim 23, wherein the program overlays an additional image over the composite image.

43. The method according to claim 23, wherein at least one of the images is a photograph.

44. The method according to claim 23, wherein the items are selected from a group consisting of: a casket, a corner adornment, a cap panel, an urn, an engraving and some combination, thereof.

45. An apparatus, comprising:
a memory resident on a local computer;
a database resident within the memory, the database storing at least one image associated with at least one of a plurality of funeral items; and
a program executing on the local computer and configured to access the database to retrieve the image, and initiate a display of the image on the local computer in response to a request from a remote network server.

46. An apparatus, comprising:
a memory resident on a local computer;
a database resident within the memory, the database storing at least one base image associated with a first funeral item and at least one overlay image associated with a correlated funeral item; and
a program executing on the local computer and configured to access the database to retrieve and initiate a display of the base image; the program further superimposing the overlay image over the base image in response to a request from a remote network server.

47. An apparatus, comprising:
a memory resident on a network server;
a program resident within the memory and in communication with a local computer, the program configured to direct the local computer to display an image associated with a funeral item in response to a request initiated by the local computer.

48. A program product, comprising:
a program configured to access a database storing images associated with a plurality of funeral products and retrieve a base image associated with one of the plurality of funeral items, display the base image, and superimpose an overlay image of a correlated item of the plurality of funeral items over the base image in such a manner as to form a composite image; and
a signal bearing medium bearing the program.

49. The program product of claim 48, wherein the signal bearing medium includes at least one of a recordable medium and a transmission medium.

50. A program product, comprising:
a program executing on the local computer and configured to access a database storing images associated with a plurality of funeral products, and to retrieve and initiate a display of a funeral item image on the local computer in response to a request from a remote network; and
a signal bearing medium bearing the program.

51. The program product of claim 50, wherein the signal bearing medium includes at least one of a recordable medium and a transmission medium.
